(19) United States
(12) Patent Application Publication
(10) Pub. No.: US 2013/0181686 A1
(43) Pub. Date: Jul. 18, 2013

(54) DISCHARGE CONTROLLER AND ELECTRIC VEHICLE

(71) Applicant: Kazuhiko UEDA, Seto-shi (JP)

(72) Inventor: Kazuhiko UEDA, Seto-shi (JP)

(73) Assignee: TOYOTA JIDOSHA KABUSHIKI KAISHA, Toyota-shi (JP)

(21) Appl. No.: 13/739,514

(22) Filed: Jan. 11, 2013

(30) Foreign Application Priority Data
Jan. 13, 2012 (JP) 2012-005563

(51) Int. Cl. H02J 7/00

(52) U.S. Cl. CPC H02J 7/0031
USPC 320/166

(57) ABSTRACT

A discharge controller is configured to periodically receive from a host controller a pulse signal, as a discharge control signal, which indicates a command for controlling a discharge device that discharges a capacitor, and when a duty ratio of the received discharge control signal deviates from a predetermined duty ratio of the discharge control signal, control the discharge device on the basis of a last command indicated by the discharge control signal received last time.

### INCORPORATION BY REFERENCE

The disclosure of Japanese Patent Application No. 2012-005563 filed on Jan. 13, 2012 including the specification, drawings and abstract is incorporated herein by reference in its entirety.

### BACKGROUND OF THE INVENTION

1. Field of the Invention

The invention relates to a discharge controller that controls a discharge device for discharging a capacitor and an electric vehicle that includes the discharge controller.

2. Description of Related Art

There is a system that includes a large-capacitance capacitor. A large-capacitance capacitor may be used in an electrical device in order to smooth current or voltage. In addition, there is a system that uses a large-capacitance capacitor as a type of battery.

An electric vehicle serves as a typical system that includes a large-capacitance capacitor. In an electric vehicle, a drive motor has a rated output of several tens of kilowatts or above, so a large current flows through the drive motor. Therefore, a large-capacitance capacitor is used to smooth current that flows through a voltage converter and an inverter. Alternatively, there is an electric vehicle on which a capacitor is mounted as a battery that stores electric power for driving a motor, as well as a lead-acid battery, a lithium-ion battery, a fuel cell, and the like.

A leakage of electric power stored in such a large-capacitance capacitor may influence another device, so, where necessary, a discharge device that is used to quickly discharge the large-capacitance capacitor may be used.

A system that includes a discharge device includes a discharge controller that controls the discharge device and a host controller that issues commands to the discharge controller.

In this case, communication is carried out between the host controller and the discharge controller; however, due to various factors, a communication line may break or large noise may be generated in the communication line and, as a result, a signal waveform may be disturbed. Therefore, it has been suggested to improve the reliability of communication data between the host controller and the discharge controller. A technique for improving the reliability of communication between the controllers is, for example, described in Japanese Patent Application Publication No. 2004-234207 (JP 2004-234207 A) and Japanese Patent Application Publication No. 6-290160 (JP 6-290160 A). JP 2004-234207 A describes a circuit that receives a switch signal for turning on or off a relay and that includes communication monitoring means for monitoring whether the communication status of the switch signal is normal. However, additional provision of means for monitoring a communication status increases cost.

### SUMMARY OF THE INVENTION

The invention provides a discharge controller and an electric vehicle that improve the reliability of communication between a host controller and the discharge controller without providing monitoring means, or the like.

A first aspect of the invention is discharge controller configured to periodically receive from a host controller a pulse signal, as a discharge control signal, which indicates a command for controlling a discharge device that discharges a capacitor, and, when a duty ratio of the received discharge control signal deviates from a predetermined duty ratio of the discharge control signal, control the discharge device on the basis of a last command indicated by the discharge control signal received last time.

The discharge control signal may indicate one of permission of the use of the discharge device and prohibition of the use of the discharge device. The discharge controller may be configured to control the discharge device to discharge the capacitor when the discharge controller has received from the host controller a trigger signal, which indicates a command to use the discharge device, in a state where the received discharge control signal indicates the permission of the use of the discharge device.

A second aspect of the invention is an electric vehicle including: one of a first capacitor, which is incorporated in an electric circuit between a battery and a drive motor and which smoothes current supplied to the motor, and a second capacitor, which temporarily stores electric power; a discharge device that discharges the one of the capacitors; a discharge controller configured to control the discharge device; and a host controller configured to periodically transmit a pulse signal, as a discharge control signal, which indicates one of permission of the use of the discharge device and prohibition of the use of the discharge device, wherein, when a duty ratio of the discharge control signal received by the discharge controller does not coincides with any one of a permission duty ratio, which indicates the permission of the use of the discharge device, and a prohibition duty ratio, which indicates the prohibition of the use of the discharge device, the discharge controller is configured to maintain a state of one of the permission of the use of the discharge device and the prohibition of the use of the discharge device, which is indicated by the discharge control signal received last time.

When the duty ratio of the discharge control signal received by the discharge controller coincides with one of the permission duty ratio and the prohibition duty ratio, the discharge controller may be configured to store a state of one of the permission of the use of the discharge device and the prohibition of the use of the discharge device, which is indicated by the received discharge control signal.

The host controller may be configured to transmit a trigger signal, which is different from the discharge control signal and which indicates a command to use the discharge device, to the discharge controller. When the stored state at the time when the discharge controller has received the trigger signal is the permission of the use of the discharge device, the discharge controller may be configured to control the discharge device to discharge the one of the first capacitor and the second capacitor.

According to the configurations described above, it is possible to improve the reliability of communication between a host controller and the discharge controller.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram of a hybrid vehicle according to an embodiment;

FIG. 2 is a flowchart of processes that are executed by a discharge controller; and

FIG. 3A and FIG. 3B are examples of a time chart of a discharge control signal and a trigger signal.

### DETAILED DESCRIPTION OF EMBODIMENTS

Hereinafter, an electric vehicle that serves as a system that includes a large-capacitance capacitor will be described, for example.

If such an electric vehicle comes into collision, it is desirable to quickly discharge the large-capacitance capacitor. For example, a resistor (discharge resistor) having a large electrical resistance and a high heat resistance is used to discharge the capacitor. Hereinafter, a device that discharges the capacitor is termed discharge device. When electric power is caused to flow from the capacitor to such a resistor, electric energy is converted to thermal energy and then the thermal energy is dissipated. The device that discharges the capacitor just needs to convert electric energy to heat or other energy (such as sound) and then dissipate the heat or other energy, so the device is not limited to the discharge resistor. It is also suggested to use a horn as the discharge device.

Meanwhile, a recent electric vehicle includes many computer-controlled devices, so the number of controllers that control those devices also increases. The electric vehicle that uses the discharge device includes, in addition to a discharge controller, a controller (airbag controller) that controls an airbag in the event of a collision and a host controller that integrates a state of the vehicle overall and determines whether to activate the discharge device.

Here, immediately after a collision, a communication line may break or large noise may be generated in the communication line and, as a result, a signal waveform may be disturbed. Thus, in the event of a collision, it is required to improve the reliability of communication between the host controller and the discharge controller.

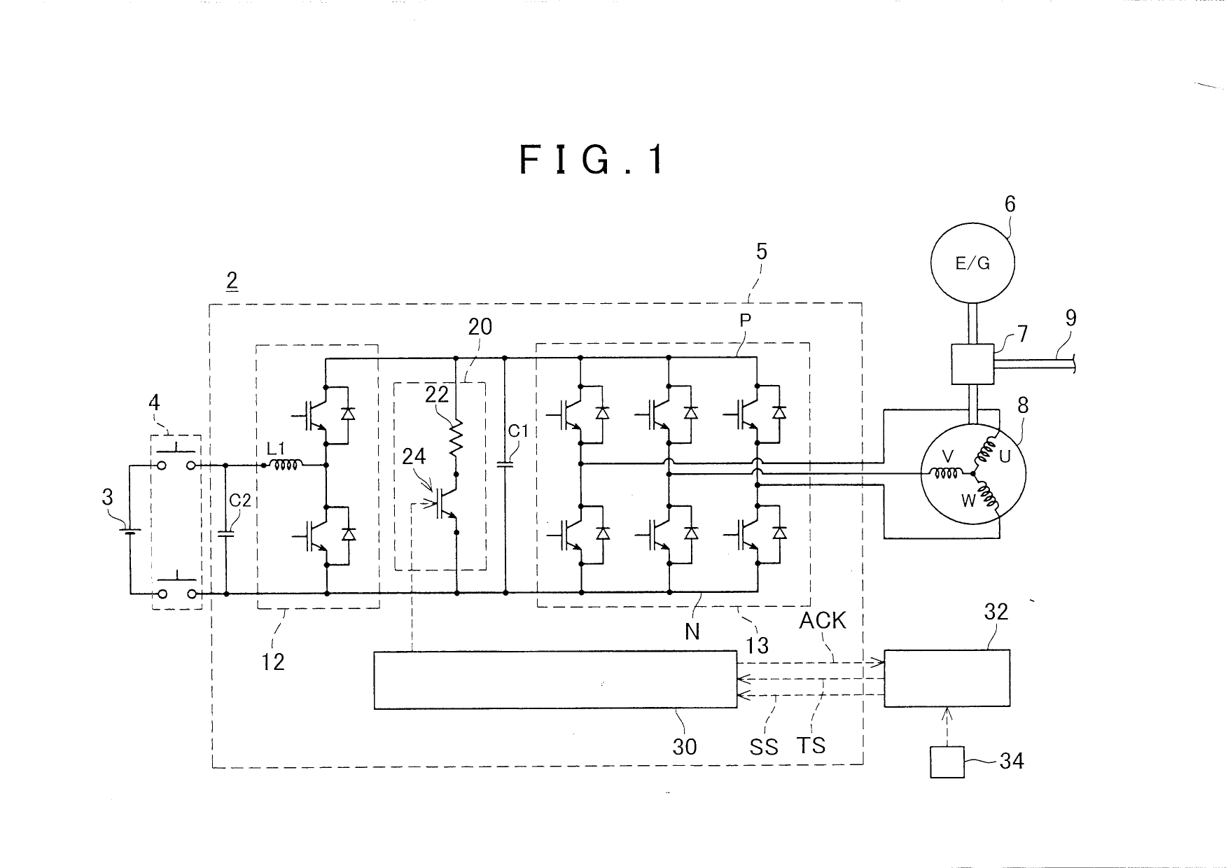

An electric vehicle according to an embodiment will be described with reference to the accompanying drawings. The electric vehicle according to the embodiment is a hybrid vehicle 2 that includes both a motor and an engine as driving sources for propelling the vehicle. FIG. 1 shows a block diagram of the hybrid vehicle 2. The hybrid vehicle 2 includes the motor 8 and the engine 6. The output torque of the motor 8 and the output torque of the engine 6 are appropriately distributed or combined by a power distribution mechanism 7, and the distributed or combined torque is transmitted to an axle 9 (that is, a wheel). Note that FIG. 1 draws only components that are required to illustrate the present embodiment and part of components irrespective of illustration are omitted.

Electric power that is used to drive the motor 8 is supplied from a main battery 3. The output voltage of the main battery 3 is, for example, 300 volts. Although not shown in the drawing, the hybrid vehicle 2 also includes an auxiliary battery in addition to the main battery 3. The auxiliary battery is used to supply electric power to devices (generally called “auxiliary devices”), such as a car navigation system and a room lamp, that are driven at a voltage lower than the output voltage of the main battery 3. The term “main battery” is used to be distinguished from the “auxiliary battery” for the sake of convenience.

The main battery 3 is connected to an inverter 5 via a system main relay 4. The system main relay 4 is a switch that connects or interrupts the main battery 3 to or from a drive system of the vehicle. The system main relay 4 is switched by a host controller 32.

The inverter 5 includes a voltage converter circuit 12 and an inverter circuit 13. The voltage converter circuit 12 steps up the voltage of the main battery 3 to a voltage (for example, 600 volts) appropriate for driving the motor. The inverter circuit 13 converts stepped-up direct-current power to alternating-current power. The output of the inverter circuit 13 corresponds to electric power supplied to the motor 8. Note that the hybrid vehicle 2 is able to generate electric power with the use of the motor 8 from the driving force of the engine 6 or the deceleration energy of the vehicle. When the motor 8 generates electric power, the inverter circuit 13 converts alternating-current power to direct-current power, and the voltage converter circuit 12 steps down the direct-current power to a voltage that is slightly higher than that of the main battery 3, and then supplies the resultant direct-current power to the main battery 3. The voltage converter circuit 12 and the inverter circuit 13 each are a circuit that is mainly formed of a switching element, such as an IGBT. A controller 30 generates and supplies a driving signal (PWM signal) for each switching element. The controller 30, a control unit of the inverter 5 and that generates a PWM signal, serves as the discharge controller 30 that controls the discharge device as will be described later.

A capacitor C2 is connected to a low voltage side (that is, a main battery side) of the voltage converter circuit 12 in parallel with the voltage converter circuit 12. A capacitor C1 is connected to a high voltage side (that is, an inverter circuit side) of the voltage converter circuit 12 in parallel with the voltage converter circuit 12. The capacitor C2 is inserted in order to smooth current that the main battery 3 outputs, and the capacitor C1 is inserted in order to smooth current that is input to the inverter circuit 13. Note that a high potential-side line of a switching element group of the inverter circuit 13 is termed P line and a ground potential-side line is termed N line. The capacitor C1 is inserted between the P line and the N line. Large current is supplied from the main battery 3 to the motor 8, so the capacitor C2 and the capacitor C1 each are a large-capacitance capacitor.

The discharge device 20 is connected in parallel with the voltage converter circuit 12 and the inverter circuit 13. In other words, the discharge device 20 is connected between the P line and N line of the inverter circuit 13. The discharge device 20 is formed by serially connecting a resistor (discharge resistor 22) having a high resistance value and a high heat resistance with a switching transistor 24. The discharge controller 30 controls on/off states of the switching transistor 24. When the switching transistor 24 is turned on, the discharge resistor 22 is connected to the circuit, and electric charge stored in the capacitor C2 and the capacitor C1 flows through the discharge resistor 22. Electric power flowing through the discharge resistor 22 dissipates in form of thermal energy. That is, the discharge resistor 22 discharges the capacitor C2 and the capacitor C1.

The discharge controller 30 directly controls the discharge device 20. However, the host controller 32 issues a command for permission or prohibition of the use of the discharge device 20 or issues a command to use the discharge device 20. The host controller 32 receives a signal from a controller of an airbag system that includes an acceleration sensor (airbag controller 34) and signals from other controllers and sensors, integrates pieces of information indicated by those signals, and determines whether to use the discharge device 20.

In association with control over the discharge device 20, the host controller 32 transmits two types of signals to the discharge controller 30. One is a discharge control signal SS, and the other one is a trigger signal TS. In addition, in association with control over the discharge device 20, an acknowledgement signal ACK is transmitted from the discharge controller 30 to the host controller 32. The discharge control signal is a signal by which the host controller 32 issues a command to the discharge controller 30 on permission or prohibition of the use of the discharge device 20. The discharge control signal is a pulse signal that is periodically transmitted, and the duty ratio of the discharge control signal indicates one of permission and prohibition of the use of the discharge device 20. The trigger signal is a signal by which the host controller 32 issues a command to the discharge controller 30 to use the discharge device 20. The trigger signal is normally a low level, and, when the host controller 32 issues a command to the discharge controller 30 to use the discharge device 20, the host controller 32 changes the signal level of the trigger signal to a high level. A rising edge of the trigger signal from the low level to the high level corresponds to a command to use the discharge device 20. The acknowledgement signal is a signal that informs the host controller 32 that the discharge controller 30 has received the discharge control signal, and indicates prohibition or permission of the use of the discharge device 20 by the same protocol as that of the discharge control signal. The above signals are transmitted via a photocoupler. That is, the host controller 32 and the discharge controller 30 are electrically isolated from each other.

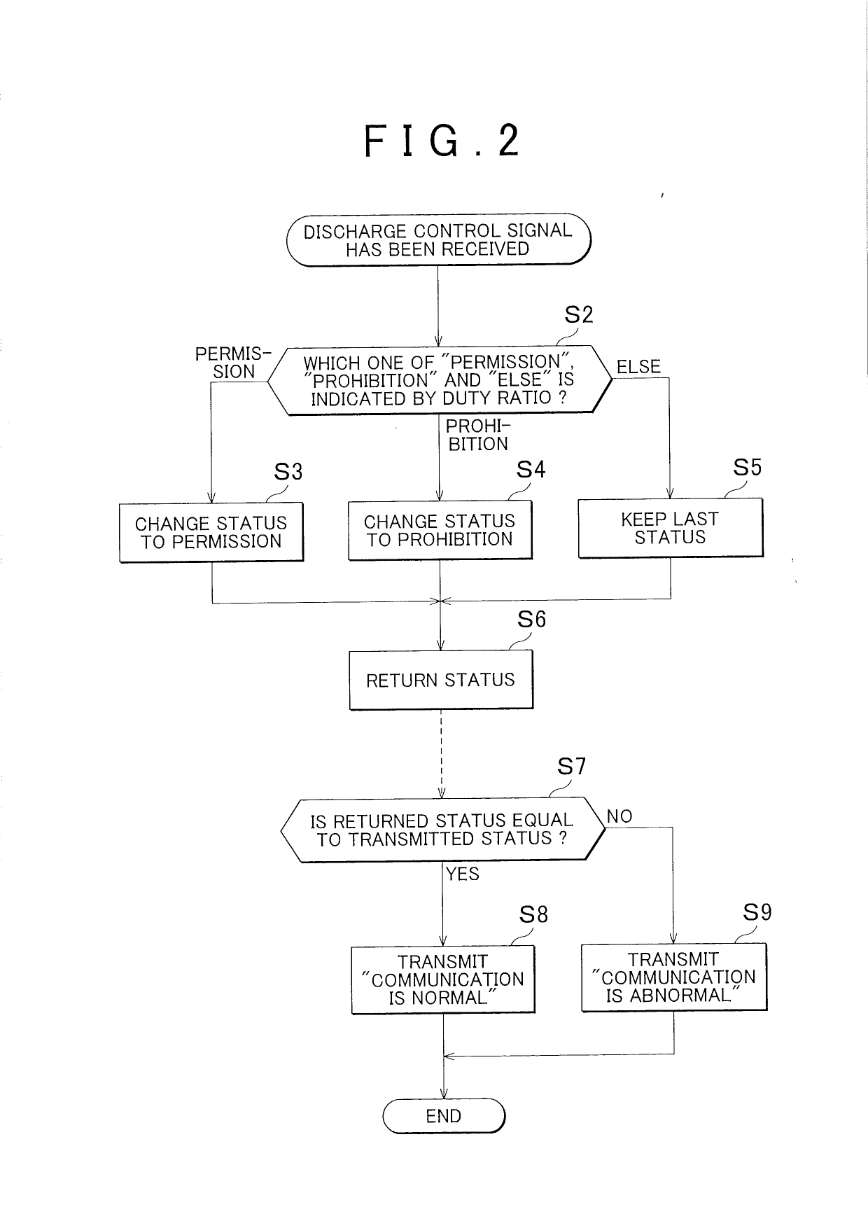

FIG. 2 shows the flowchart of processes that are executed by the discharge controller 30 upon reception of the discharge control signal and subsequent processes that are executed by the host controller 32. In FIG. 2, steps S2 to S6 are processes that are executed by the discharge controller 30, and steps S7 to S9 are processes that are executed by the host controller 32. When the discharge controller 30 receives the discharge control signal, the discharge controller 30 compares the duty ratio of the discharge control signal with prestored two duty ratios (S2). The discharge controller 30 stores a duty ratio (prohibition duty ratio) that indicates prohibition of the use of the discharge device 20 and a duty ratio (permission duty ratio) that indicates permission of the use of the discharge device 20. When the duty ratio of the received discharge control signal coincides with the permission duty ratio, the discharge controller 30 changes a status stored in its own memory to “permission” (S3). When the duty ratio of the received discharge control signal coincides with the prohibition duty ratio, the discharge controller 30 changes the status to “prohibition” (S4). Note that the status is a state that is defined in a program of the discharge controller 30 and corresponds to a state that indicates one of prohibition and permission of the use of the discharge device 20. In addition, the “coincidence” here means whether the duty ratio of the received signal coincides with the stored prohibition duty ratio or permission duty ratio within a predetermined tolerance. The tolerance may be, for example, set within ±5% of the duty ratio. When the duty ratio of the received discharge control signal does not coincide with any of the prohibition duty ratio and the permission duty ratio, the discharge controller 30 keeps the last status (S5). Finally, the discharge controller 30 returns the stored status to the host controller 32 by the same protocol as that of the discharge control signal (S6).

When the returned status coincides with the status of the discharge device 20, indicated by the discharge control signal transmitted to the discharge controller 30 (the status transmitted to the discharge controller 30) (YES in S7), the host controller 32 transmits a signal that indicates that communication is normally carried out to another controller (YES in S7). On the other hand, when the returned status does not coincide with the status transmitted to the discharge controller 30 (NO in S7), the host controller 32 transmits a signal that indicates that communication has not been normally carried out to another controller (S9). Here, another controller is, for example, an overall controller that intensively manages or determines information about the vehicle overall.

When the host controller 32 receives a signal, that indicates that the airbag has been activated (that is, a signal that indicates that the vehicle has come into collision) from the airbag controller 34, the host controller 32 determines whether the discharge device 20 needs to be used on the basis of other pieces of information as well. When it is determined that the discharge device 20 needs to be used, the host controller 32 transmits the trigger signal, of which the voltage level is set to the high level, to the discharge controller 30. When the discharge controller 30 has received the high-level trigger signal from the host controller 32, the discharge controller 30 immediately uses the discharge device 20 when the stored status is “permission”. That is, the switching transistor 24 is switched to an on state. On the other hand, even when the discharge controller 30 has received the trigger signal, the discharge controller 30 ignores the trigger signal when the stored status is “prohibition”. That is, the discharge controller 30 does not use the discharge device 20.

An example of hardware/software configuration relating to reception of the trigger signal is as follows. An interrupt process that is started in response to the rising edge of the trigger signal is allocated to an Input/Output port of the discharge controller 30 that receives the trigger signal. A program that outputs a signal for turning on the switching transistor 24 in the case where the stored status is “permission” is prescribed as the interrupt process.

The advantage of the above-described processes in the hybrid vehicle 2 according to the embodiment will be described. The flowchart shown in FIG. 2 is repeated periodically (for example, at intervals of 10 milliseconds). Through the processes of the flowchart shown in FIG. 2, the discharge controller 30 is constantly able to determine, on the basis of the stored status, whether the discharge device 20 is permitted to be immediately used (in the case where the status is “permission”) or the discharge device 20 is not used by ignoring the trigger signal (in the case where the status is “prohibition”) if the discharge controller 30 has received from the host controller 32 a command (trigger signal) to use the discharge device 20 while the vehicle is travelling. When the vehicle has come into collision, it is expected that a malfunction occurs in various devices and signal lines, so it is desirable to quickly use the discharge device 20 when the host controller 32 determines that the discharge device 20 needs to be used. When the host controller 32 according to the present embodiment determines that the discharge device 20 needs to be used, the host controller 32 may immediately transmit the trigger signal without determining whether the discharge device is permitted to be used. When the discharge controller 30 receives the trigger signal, the discharge controller 30 is able to determine whether the discharge device 20 is permitted to be used on the basis of the stored status without waiting for a new discharge control signal. That is, the discharge controller 30 is able to reduce a processing time from when the host controller 32 determines that the discharge device 20 needs to be used to when the discharge device 20 is used.

Furthermore, when a malfunction occurs in the signal line due to a collision and the discharge control signal is transmitted and received at the instance of or immediately after the collision, the signal may be disturbed and the contents of the signal may be unclear. That is, the latest discharge control signal may become unclear. In contrast to this, the discharge controller 30 according to the present embodiment maintains the last status if the received discharge control signal is unclear. This process prevents the status stored in the discharge controller 30 from becoming unclear, and improves the reliability of communication between the host controller 32 and the discharge controller 30.

The discharge controller 30 according to the present embodiment determines the status by comparing the duty ratio of the discharge control signal with the prestored reference duty ratios. By so doing, it is possible to quickly determine whether the received discharge control signal is normal. Furthermore, by separating the discharge control signal that permits or prohibits the use of the discharge device 20 from the trigger signal that provides a command to use the discharge device 20, it is possible to improve the reliability of the discharge system. That is, by periodically transmitting the discharge control signal separately from the trigger signal, the host controller 32 is able to quickly transmit the trigger signal upon detection of a collision irrespective of transmission of the discharge control signal. When the discharge controller 30 has received the trigger signal, the discharge controller 30 is able to determine whether the discharge device 20 is used on the basis of the stored status. Upon detection of a collision, a certain period of time is required to transmit and receive both the discharge control signal and the trigger signal. During the period of time, the circuit may malfunction or the signal line may become instable. When the above-described algorithm/protocol is employed, only transmission and reception of the trigger signal are required. Therefore, it is possible to quickly use the discharge device 20, and it is possible to decrease the likelihood of the above-described situation.

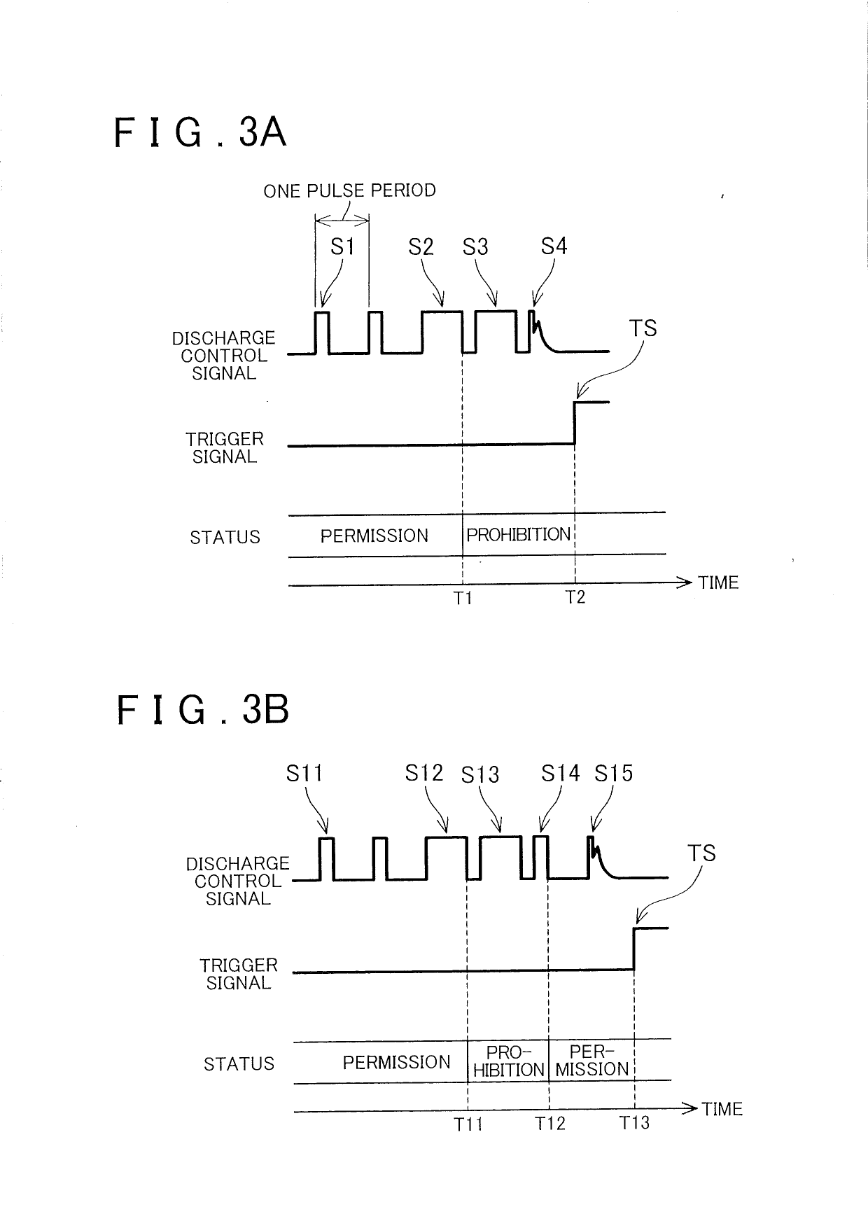

FIG. 3A and FIG. 3B show two examples of a time chart of the discharge control signal and the trigger signal. In FIG. 3A and FIG. 3B, the discharge control signal includes two types of pulse signals having different duty ratios. In this example, signals having a small duty ratio (signals S1, S11 and S14) indicate permission of the use of the discharge device 20, and signals having a large duty ratio (signals S2, S3, S12 and S13) indicate prohibition of the use of the discharge device. The host controller 32 transmits one of a pulse signal that indicates “permission” and a pulse signal that indicates “prohibition” at each pulse period. In the example of FIG. 3A, the status of the discharge device 20 is initially “permission”, and, upon reception of the signal S2 having the prohibition duty ratio at time T1, the discharge controller 30 changes the stored status to “prohibition”. Because the next signal S3 also has the prohibition duty ratio, the status remains in “prohibition”. It is assumed that the vehicle comes into collision in the middle of the next signal S4. A signal waveform is disturbed in the middle of the signal S4, and the duty ratio of the signal S4 cannot be determined as the prohibition duty ratio or the permission duty ratio. In this case, the discharge controller 30 maintains the last status “prohibition”. For example, after that, when the discharge controller 30 has received a trigger signal TS at time T2, the discharge controller 30 does not use the discharge device 20 because the stored status is “prohibition”.

On the other hand, in the example of FIG. 3B, because the discharge controller 30 has received the signal S12 having the prohibition duty ratio at time T11, the discharge controller 30 changes the status to “prohibition”. After that, when the discharge controller 30 receives the signal S14 having the permission duty ratio at time T12, the discharge controller 30 changes the status to “permission”. Then, the vehicle comes into collision, the signal is disturbed during receiving the signal S15, and the duty ratio of the signal S15 cannot be determined as the prohibition duty ratio or the permission duty ratio. In this case, the discharge controller 30 maintains the last status “permission”. After that, when the discharge controller 30 has received the trigger signal TS at time T13, the discharge controller 30 uses the discharge device 20 because the stored status is “permission”.

In the examples of FIG. 3A and FIG. 3B, the pulse signals (51, S11 and S14) having a small duty ratio are discharge control signals having a duty ratio (permission duty ratio) that indicates permission of the use of the discharge device 20, and the pulse signals (S2, S3, S12 and S13) having a large duty ratio are discharge control signals having a duty ratio (prohibition duty ratio) that indicates prohibition of the use of the discharge device 20. Thus, the host controller 32 periodically transmits the discharge control signal that includes one of the pulse signal having the permission duty ratio and the pulse signal having the prohibition duty ratio to the discharge controller 30. In this case, when the duty ratio of the received discharge control signal is neither the predetermined permission duty ratio nor the predetermined prohibition duty ratio, the discharge controller 30 maintains a state of prohibition or permission of the use of the discharge device 20, which is indicated by the discharge control signal received last time. A waveform that is shown by the discharge control signal is not limited to the waveform of FIG. 3A or FIG. 3B. Different two types of duty ratios just need to be respectively allocated to prohibition and permission of the use of the discharge device 20. Note that the discharge control signal that is transmitted at each pulse period has one of the permission duty ratio and the prohibition duty ratio; however, the discharge control signal over time (that is, the discharge control signal indicated in the time charts) mixedly includes a pulse having the permission duty ratio and a pulse having the prohibition duty ratio.

In the present embodiment, the discharge controller that executes discharge control over the capacitor that smoothes current is described as an example. The capacitor may be used to adjust (smooth) the voltage of the circuit or may be mounted as a battery. The discharge controller according to the aspect of the invention may be applied to a system other than an electric vehicle, that is, for example, an electric motorcycle, a home electric appliance, a production system installed in a factory, or the like.

The embodiment of the invention is described in detail above; however, it is just illustrative and not intended to limit the scope of the claims. The technique described in the appended claims encompasses various modifications and alterations of the above-described example embodiment. The technical elements described in the specification and the drawings exhibit technical utility alone or in various combinations and are not limited to the combinations described in the appended claims at the time of filing. In addition, the technique described in the specification and the drawings achieves multiple purposes at the same time, and it also has technical utility by achieving one of those purposes.

What is claimed is:

1. A discharge controller configured to:
periodically receive from a host controller a pulse signal, as a discharge control signal, which indicates a command for controlling a discharge device that discharges a capacitor; and
when a duty ratio of the received discharge control signal deviates from a predetermined duty ratio of the discharge control signal, control the discharge device on the basis of a last command indicated by the discharge control signal received last time.

2. The discharge controller according to claim 1, wherein:
the discharge control signal indicates one of permission of the use of the discharge device and prohibition of the use of the discharge device; and
the discharge controller is configured to control the discharge device to discharge the capacitor when the discharge controller has received from the host controller a trigger signal, which indicates a command to use the discharge device, in a state where the received discharge control signal indicates the permission of the use of the discharge device.

3. An electric vehicle comprising:
one of a first capacitor, which is incorporated in an electric circuit between a battery and a drive motor and which smoothes current supplied to the motor, and a second capacitor, which temporarily stores electric power;
a discharge device that discharges the one of the capacitors;
a discharge controller configured to control the discharge device; and
a host controller configured to periodically transmit a pulse signal, as a discharge control signal, which indicates one of permission of the use of the discharge device and prohibition of the use of the discharge device, wherein
when a duty ratio of the discharge control signal received by the discharge controller does not coincides with any one of a permission duty ratio, which indicates the permission of the use of the discharge device, and a prohibition duty ratio, which indicates the prohibition of the use of the discharge device, the discharge controller is configured to maintain a state of one of the permission of the use of the discharge device and the prohibition of the use of the discharge device, which is indicated by the discharge control signal received last time.

4. The electric vehicle according to claim 3, wherein, when the duty ratio of the discharge control signal received by the discharge controller coincides with one of the permission duty ratio and the prohibition duty ratio, the discharge controller is configured to store a state of one of the permission of the use of the discharge device and the prohibition of the use of the discharge device, which is indicated by the received discharge control signal.

5. The electric vehicle according to claim 4, wherein:
the host controller is configured to transmit a trigger signal, which is different from the discharge control signal and which indicates a command to use the discharge device, to the discharge controller; and
when the stored state at the time when the discharge controller has received the trigger signal is the permission of the use of the discharge device, the discharge controller is configured to control the discharge device to discharge the one of the first capacitor and the second capacitor.
